(19) United States
(12) Patent Application Publication
(10) Pub. No.: US 2024/0196091 A1
(43) Pub. Date: Jun. 13, 2024

(54) IMAGE CAPTURING DEVICE AND METHOD

(71) Applicant: MEDIATEK INC., Hsinchu City (TW)

(72) Inventors: Bo-Ying CHEN, Hsinchu City (TW); Ping-Hsien LEE, Hsinchu City (TW); Chih-Hsiang YU, Hsinchu City (TW)

(21) Appl. No.: 18/306,564

(22) Filed: Apr. 25, 2023

Related U.S. Application Data
(60) Provisional application No. 63/386,334, filed on Dec. 7, 2022.

(51) Int. Cl. H04N 23/68; H04N 23/611; H04N 23/63; H04N 23/81

(52) U.S. Cl. CPC H04N 23/6811; H04N 23/611; H04N 23/632; H04N 23/6812; H04N 23/684; H04N 23/81

(57) ABSTRACT

An image capturing device is provided. An image sensor is configured to capture an image of a target at a predetermined time interval according to a target exposure setting, to provide a series of preview frames at a frame rate. A storage device is configured to store each of the preview frames. A processor is configured to access the storage device to obtain first and second preview frames, determine a motion value of the target according to the first and second preview frames, and update the target exposure setting according to the motion value of the target. The image sensor is configured to capture the image of the target according to the updated target exposure setting to provide next preview frame.

### CROSS REFERENCE TO RELATED APPLICATIONS

This application claims the benefit of U.S. Provisional Application No. 63/386,334, filed Dec. 7, 2022, the entirety of which is incorporated by reference herein.

### BACKGROUND OF THE INVENTION

### Field of the Invention

The present invention relates to an image capturing device, and, in particular, to an image capturing device with motion-deblur.

### Description of the Related Art

Camera modules have become popular elements used in a variety of applications. For example, a smartphone is typically equipped with a camera module, thus allowing a user to easily and conveniently take pictures using a smartphone.

In photography, it is common practice to capture or record a moving object. The movement of a target object within a scene to be captured may cause the captured image to have blurry image contents. For example, when the user wants to use a smartphone to take a picture of a person running, the captured image may have image content (i.e., the person) that comes out blurry.

Therefore, an image capturing device for capturing motion-deblur and noise-robust photos is desired.

### BRIEF SUMMARY OF THE INVENTION

An embodiment of the present invention provides an image capturing device. The image capturing device includes an image sensor, a storage device and a processor. The image sensor is configured to capture an image of a target at a predetermined time interval according to a target exposure setting, to provide a series of preview frames at a frame rate. The storage device is configured to store each of the preview frames. The processor is configured to access the storage device to obtain a first preview frame and a second preview frame, determine a motion value of the target according to the first and second preview frames, and update the target exposure setting according to the motion value of the target. The image sensor is configured to capture the image of the target according to the updated target exposure setting to provide a next preview frame.

Furthermore, an embodiment of the present invention provides an image capturing method. An image of a target is captured at a predetermined time interval according to a target exposure setting, to provide a series of preview frames at a frame rate. Each of the preview frames is stored in a storage device. A first preview frame and a second preview frame are obtained from the storage device. A motion value of the target is determined according to the first and second preview frames. The target exposure setting is updated according to the motion value of the target. The image of the target is captured according to the updated target exposure setting to provide a next preview frame.

### BRIEF DESCRIPTION OF THE DRAWINGS

The present invention can be more fully understood by reading the subsequent detailed description and examples with references made to the accompanying drawings, wherein:

FIG. 1 shows an image capturing device according to some embodiments of the invention.

FIG. 2 shows an image capturing method according to some embodiments of the invention.

FIG. 3 shows a flowchart illustrating the operation in the preview state of FIG. 2 according to some embodiments of the invention.

FIG. 4 shows a flowchart illustrating the operation in the capture state of FIG. 2 according to some embodiments of the invention.

FIG. 5 shows a schematic illustrating the relationship between the exposure time of the target exposure setting and the preview frames according to some embodiments of the invention.

FIG. 6 shows a motion computing unit in the image capturing device 100 of FIG. 1 according to some embodiments of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Some variations of the embodiments are described. Throughout the various views and illustrative embodiments, like reference numbers are used to designate like elements. It should be understood that additional operations can be provided before, during, and/or after a disclosed method, and some of the operations described can be replaced or eliminated for other embodiments of the method.

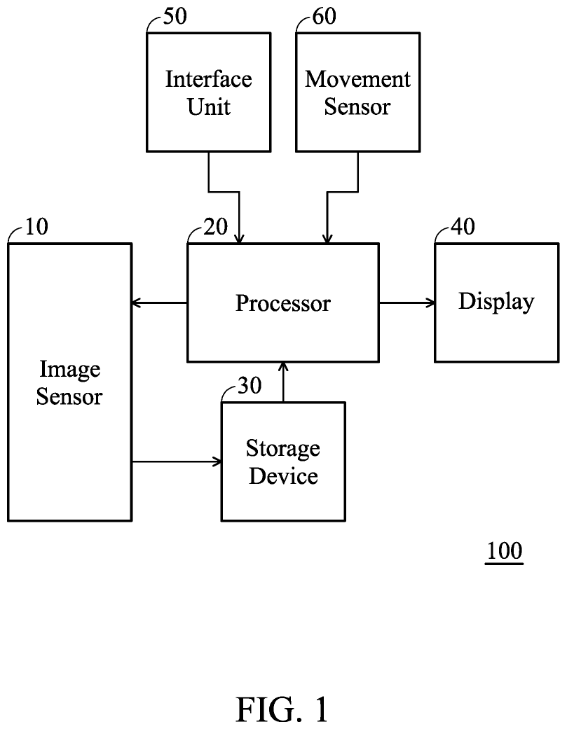

FIG. 1 shows an image capturing device 100 according to some embodiments of the invention. The image capturing device 100 is an electronic device that a user can use to capture images. For example, the image capturing device 100 may be a digital camera, a smart phone, a media player, a media recorder, a PDA, a tablet PC, a laptop computer, and so on. The image capturing device 100 includes an image sensor 10, a processor 20, a storage device 30, a display 40, an interface unit 50 and a movement sensor 60. In FIG. 1, only the components of the image capturing device 100 that are substantively related to the invention are depicted. Other components that are either unrelated to or only tangentially related to the invention are omitted from FIG. 1 for the sake of simplicity.

The image sensor 10 may be a charge-coupled device (CCD) or an active-pixel sensor (e.g., CMOS sensor). The image sensor 10 is configured to periodically capture an image of the target object according to the target exposure setting EXP_Set to provide a series of preview frames at a frame rate F_Rate. Each preview frame is captured using individual target exposure setting EXP_Set. In some embodiments, the frame rate F_Rate is fixed. For example, the image sensor 10 is capable of capturing an image of the target object to provide the corresponding preview frame every 33.3 ms, i.e., the frame rate F_Rate is 30 frames per second (e.g., 30 FPS).

After obtaining the preview frame IMG_Current currently captured, the image sensor 10 is configured to store the preview frame IMG_Current currently captured with the corresponding target exposure setting EXP_Set in the storage device 30. The storage device 30 may be a buffer or a memory, and the storage device 30 is capable of storing the current preview frame IMG_Current and the previous preview frames from the image sensor 10. In such embodiment, the target exposure setting EXP_Set of each preview frame is also stored in the storage device 30.

The processor 20 may be a dedicated hardware (e.g., an image signal processor (ISP)), or be embodied by a general purpose processor or a computation device of the image capturing device 100. The processor 20 is configured to access the storage device 30 to obtain the current image information (e.g., image data and the target exposure setting EXP_Set) of the current preview frame IMG_Current and the previously image information (e.g., image data and the target exposure setting EXP_Set) of the previous preview frame IMG_Last. The current preview frame IMG_Current is the preview frame captured by the image sensor 10 and stored in the storage device 30 in the current time interval (or cycle) corresponding to the frame rate F_Rate, and the previous preview frame IMG_Last is the preview frame captured by the image sensor 10 and stored in the storage device 30 in the previous time interval (or cycle) for the frame rate F_Rate.

According to the current image information and the previously image information, the processor 20 is configured to determine the motion value of the target object and obtain a new target exposure setting according to the motion value. In some embodiments, the processor 20 is configured to further determine the motion value of the target object according to the movement information of the image sensor (e.g., the movement of image capturing device 100) detected by the movement sensor 60. In some embodiments, the movement sensor 60 may be a gyroscope. Furthermore, the processor 20 is configured to update the new target exposure setting to the target exposure setting, so the image sensor 10 can capture the next preview frame. In other words, the target exposure setting of each preview frame is determined by two previous consecutive preview frames.

The interface unit 50 includes a button (not shown), such as a mechanical shutter button. When detecting that the user is pressing the button, the interface unit 50 is configured to provide the user input Press_In to the processor 20 to notify the processor 20 that the button has been pressed, and when it was pressed. When the user input Press_In is present, the processor 20 is configured to access the storage device 30, to select and obtain the preview frame IMG_Display to be displayed. The preview frame IMG_Display is the preview frame captured when the button was pressed. Next, the processor 20 is configured to provide the preview frame IMG_Display to the display 40 for display. The display 40 includes a display panel. In some embodiments, the display panel may be an organic light-emitting diode (OLED) display panel or a liquid-crystal display (LCD) panel. In some embodiments, the display 40 includes a touch panel (not shown), and the user input Press_In is provided by the touch panel when a virtual button on the touch panel has pressed.

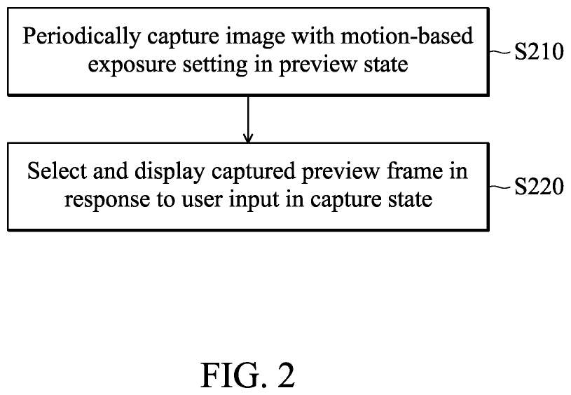

FIG. 2 shows an image capturing method according to some embodiments of the invention. The method of FIG. 2 can be performed by the image capturing device 100 of FIG. 1.

The image capturing device 100 is configured to perform the operation of a preview state when some conditions are satisfied. In some embodiments, the image capturing device 100 is configured to perform the operation of preview state after the user has enabled an image capturing mode of the image capturing device 100. In some embodiments, the image capturing device 100 is configured to perform the operation of preview state when the image capturing device 100 has located a target of potential interest to the user for image capturing.

In some embodiments, the target of interest can be a single object or a combination of several objects, or constitute only a part of one or several objects. The term object can refer to a living object, a natural object, or an artificial object. In some embodiments, the target of interest can be a person's face, and the image capturing device 100 can use a face recognition technology to locate the face. In some embodiments, the target of interest can be a target that is encompassed in a focus area selected by the image capturing device 100 automatically or by the user manually.

In step S210, the image capturing device 100 is operated in the preview state. In the preview state, the image capturing device 100 is configured to periodically capture the image of the target with motion-based exposure setting to provide a series of preview frames at a frame rate F_Rate. Furthermore, the series of preview frames are stored in the image capturing device 100. The motion-based exposure setting is the target exposure setting that is dynamically adjusted according to the motion value estimated from previous consecutive preview frames.

In step S220, in response to the user input Press_In, the image capturing device 100 is configured to select the preview frame IMG_Display from the stored preview frames for display in the capture state.

In the image capturing device 100, the processor 20 can simultaneously perform operations in the preview state and the capture state. Operations in the preview state and in the capture state will be described later.

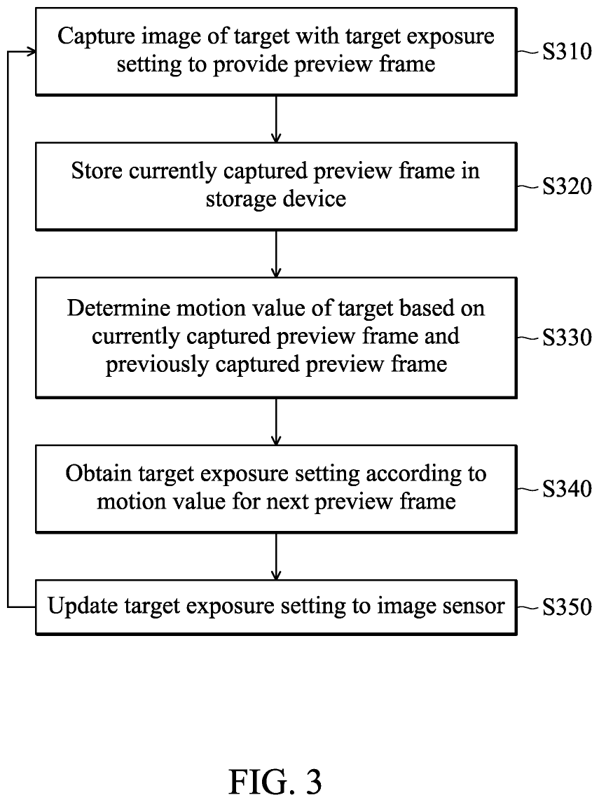

FIG. 3 shows a flowchart illustrating the operation in the preview state of FIG. 2 according to some embodiments of the invention. The flowchart of FIG. 3 is performed by the image capturing device 100 shown in FIG. 1. For the sake of simplicity, the following paragraphs will use the components of the image capturing device 100 to illustrate the steps of flowchart in FIG. 3. It should be noted that flowchart of FIG. 3 may be performed by an electronic device other than the image capturing device 100. In each time interval, step S310 through step S350 are performed sequentially. Furthermore, the time interval is determined by the frame rate F_Rate.

In step S310, the image sensor 10 is configured to capture an image of the target object according to the target exposure setting EXP_Set from the processor 20, so as to provide the current preview frame IMG_Current. In each time interval, only one preview frame is captured by the image sensor 10.

In step S320, the current preview frame IMG_Current and its target exposure setting EXP_Set are stored in the storage device 30. The capacity of storage device 30 can store multiple captured preview frames. Furthermore, the capacity of storage device 30 is determined by the various applications in the image capturing device 100.

In step S330, the processor 20 is configured to access the storage device 30, so as to read the image data and the target exposure setting EXP_Set of the current preview frame IMG_Current and the previous preview frame IMG_Last. As described above, the current preview frame IMG_Current is captured by the image sensor 10 and stored in the storage device 30 in the current time interval, and the previous preview frame IMG_Last is captured by the image sensor 10 and stored in the storage device 30 in the previous time interval. Furthermore, the current preview frame IMG_Current and the previous preview frame IMG_Last are two previous consecutive preview frames. According to the two previous consecutive preview frames, the processor 20 is configured to use an image-based technique to determine the motion value of the target between the two previous consecutive preview frames.

In step S340, the processor 20 is configured to determine the target exposure setting EXP_Set (i.e., a new target exposure setting EXP_Set is provided) according to the motion value obtained in step S330, so as to reduce motion blur and keep acceptable noise-level for the preview frame captured in the next time interval. Furthermore, the target exposure setting EXP_Set is determined by modifying an exposure value of shutter speed, aperture, sensitivity (ISO) or any combination thereof. In some embodiments, the processor 20 is configured to modify the shutter speed first, then resolution and aperture to keep acceptable noise-level.

In step S350, the processor 20 is configured to update the target exposure setting EXP_Set obtained in step S340 to the image sensor 10, so as to eliminate motion blur of the preview frame captured by the image sensor 10 in step S310 of the next time interval.

In the preview state of the image capturing device 100, the operations of step S310 through step S350 are repeated in each time interval. Furthermore, the current preview frame IMG_Current obtained in each time interval may be displayed in the display 40.

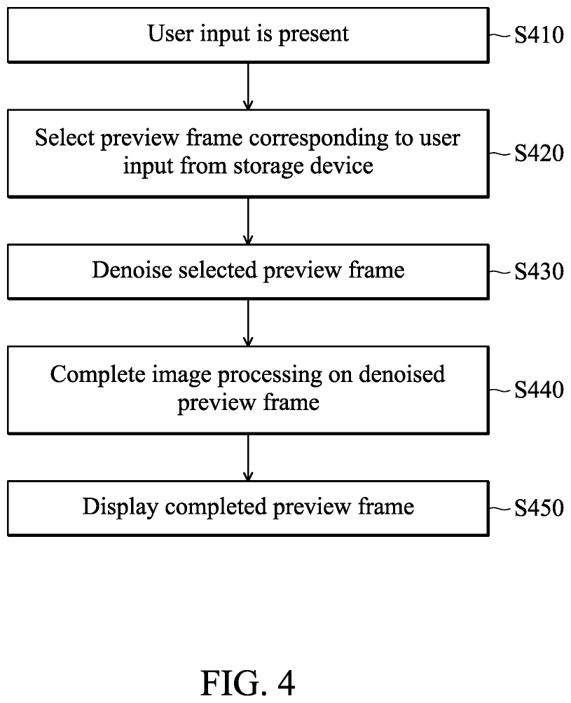

FIG. 4 shows a flowchart illustrating the operation of the capture state of FIG. 2 according to some embodiments of the invention. The flowchart of FIG. 4 is performed by the image capturing device 100 shown in FIG. 1, for the sake of simplicity, the following paragraphs will use the components of the image capturing device 100 to illustrate the steps of flowchart in FIG. 4. It should be noted that flowchart of FIG. 4 may be performed by an electronic device other than the image capturing device 100.

In step S410, when detecting that the user is pressing the button, the user input Press_In is provided to the processor 20 by the interface unit 50, and the processor 20 is configured to perform the operation in the capture state.

In step S420, in response to the user input Press_In, the processor 20 is configured to select the preview frame IMG_Display to be displayed from the storage device 30. The user input Press_In includes the information regarding that the button has been pressed and when the button has been pressed. Therefore, according to the information, the processor 20 is configured to access the storage device 30 to obtain the preview frame IMG_Display that is the preview frame captured by the image sensor 10 when the button was pressed by the user. In other words, the preview frame IMG_Display is the preview frame with zero shutter lag.

In step S430, the processor 20 is configured to use multiple frame noise reduction technique to denoise the preview frame IMG_Display from the storage device 30. Therefore, no suffering lags and jagged edges around the moving target in the preview frame IMG_Display.

In step S440, the processor 20 is configured to complete the image processing operation on the preview frame IMG_Display and store the processed preview frame IMG_Display in a memory device (not shown) of the image capturing device 100. In some embodiments, the memory device may be a secure digital memory card.

In step S450, the processor 20 is configured to provide the processed preview frame IMG_Display to the display 40 for the user to watch.

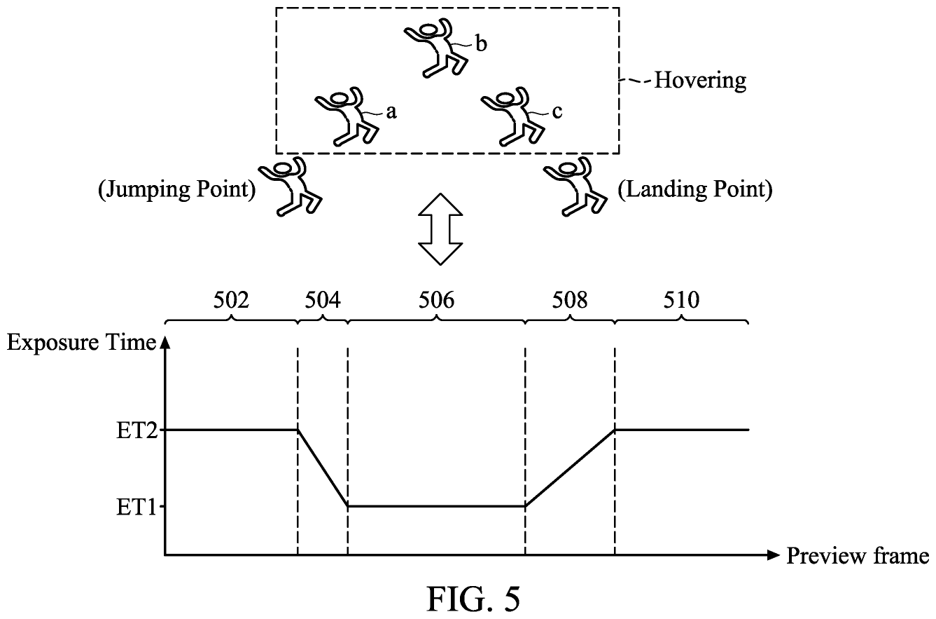

FIG. 5 shows a schematic illustrating the relationship between the exposure time of the target exposure setting EXP_Set and the preview frames according to some embodiments of the invention. In FIG. 5, the person being photographed is jumping from the jumping point to the landing point.

In FIG. 5, five time periods 502, 504, 506, 508 and 510 are shown. The flowchart of the preview state in FIG. 3 is executed repeatedly, and multiple preview frames are captured at the frame rate F_Rate in each of time periods 502, 504, 506, 508 and 510.

During the time period 502, the person hasn't started jumping, i.e., the person stays at the jump point. Since the person is stationary, the motion value estimated from two previous consecutive preview frames is fixed, and the exposure time of the target exposure setting EXP_Set remains at ET2.

During the time period 504, the person starts jumping from the jumping point. Since the person starts moving from a stationary state, the motion value estimated from two previous consecutive preview frames change gradually, and the exposure time of the target exposure setting EXP_Set is changed from ET2 to ET1.

During the time period 506, the person will hover in the air from point “a” to point “c” through point “b”. Since the person is moving at roughly the same speed (e.g. the motion value Motion_Value of the target object is not greater than a threshold value), the motion value estimated from two previous consecutive preview frames will not change, and the exposure time of the target exposure setting EXP_Set remains at ET1.

During the time period 508, the person begins to move to the landing point. Since the person starts to stand, the motion value estimated from two previous consecutive preview frames change gradually, and the exposure time of the target exposure setting EXP_Set is changed from ET1 to ET2.

During the time period 510, the person has finished jumping, i.e., the person stays at the landing point. Since the person is stationary, the motion value estimated from two previous consecutive preview frames is fixed, and the exposure time of the target exposure setting EXP_Set remains at ET2.

In FIG. 5, when the person being photographed is jumping from the jumping point to the landing point, the image sensor 10 is configured to periodically capture an image of the person according to the target exposure setting EXP_Set continuously updated by the processor 20, so as to provide and store a series of preview frames without motion-blur. When the user presses the button to take a photo of the jumping person, the processor 20 is configured to access the storage device 30 to obtain the taken image according to information of the user input Press_In, and the taken image is the preview frame captured when the button was pressed. After the taken image is obtained from the storage device 30, the processor 20 is configured to display the taken image with zero shutter lag via the display 40.

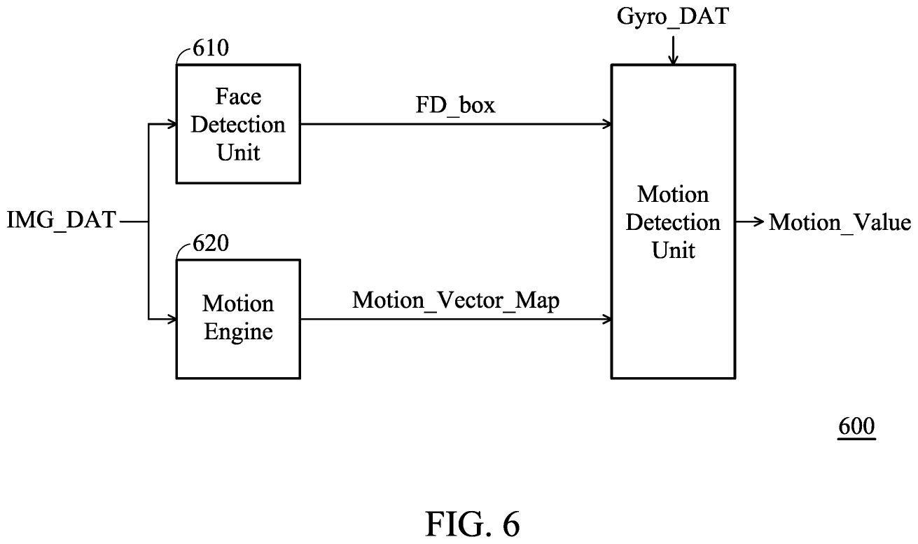

FIG. 6 shows a motion computing unit 600 in the image capturing device 100 of FIG. 1 according to some embodiments of the invention. In such embodiment, the motion computing unit 600 is implemented in the processor 20. The motion computing unit 600 includes a face detection unit 610, a motion engine 620 and a motion detection unit 630. The face detection unit 610 is configured to detect face feature in the image data IMG_DAT to provide the local motion FD_box. In such embodiment, the image data includes information of the current preview frame IMG_Current and the previous preview frame IMG_Last. Furthermore, the motion engine 620 is configured to detect object feature in the image data IMG_DAT to provide a local motion Motion_Vector_Map. The motion detection unit 630 is configured to provide the motion value Motion_Value of the target object according to the local motion Motion_Vector_Map, the local motion FD_box, and a global motion Gyro_DAT. The global motion Gyro_DAT is the movement information of the image sensor 10 (or the movement information of the image capturing device 100 provided by the movement sensor 60 (e.g., a gyroscope) of FIG. 1.

In some embodiments, the motion computing unit 600 is configured to obtain motion in pixel (MIP) according to the motion value Motion_Value. If the obtained MIP is greater than a target MIP (e.g., a threshold value), the image capturing device 100 is configured to adjust the target exposure setting EXP_Set for capturing the next preview frame. If the obtained MIP is less than or equal to the target MIP, the image capturing device 100 is configured to keep the target exposure setting EXP_Set for capturing the next preview frame.

In FIG. 6, the computing of the motion value Motion_Value in the motion computing unit 600 is an example, and not to limit the invention. In some embodiments, the motion computing unit 600 may use the known motion analysis technology to obtain the motion value Motion_Value between the current preview frame IMG_Current and the previous preview frame IMG_Last.

Compared with the traditional image capturing device with worse noise level in image quality caused by decreased exposure time with higher ISO, the image capturing device 100 is capable of adaptively decrease the exposure time according to the motion value Motion_Value in the preview state. Thus, the noise level can be well maintained and the image has good motion clarity. Furthermore, in response to the user input Press_In, one of the previously captured and stored preview frames is selected as the preview frame IMG_Display (i.e., zero-shutter-lag frame) regardless of shutter lag and other delays caused by the mage capturing device 100.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capturing device, comprising:
an image sensor configured to capture an image of a target at a predetermined time interval according to a target exposure setting, to provide a series of preview frames at a frame rate;
a storage device configured to store each of the preview frames; and
a processor configured to access the storage device to obtain a first preview frame and a second preview frame, determine a motion value of the target according to the first and second preview frames, and update the target exposure setting according to the motion value of the target,
wherein the image sensor is configured to capture the image of the target according to the updated target exposure setting to provide a next preview frame.

2. The image capturing device as claimed in claim 1, wherein the processor is configured to perform an image processing operation on the preview frame to be displayed, so as to obtain a denoised image.

3. The image capturing device as claimed in claim 2, further comprising:
a display configured to display the denoised image.

4. The image capturing device as claimed in claim 3, wherein the display is configured to display the preview frames at the frame rate.

5. The image capturing device as claimed in claim 1, wherein the frame rate is fixed.

6. The image capturing device as claimed in claim 1, wherein in response to a user input, the processor is configured to access the storage device to obtain the preview frame to be displayed, and the preview frame to be displayed is the preview frame having the image of the target captured by the image sensor when the user input is present.

7. The image capturing device as claimed in claim 1, wherein the target exposure setting comprises an exposure value of shutter speed, aperture, and sensitivity.

8. The image capturing device as claimed in claim 1, wherein the storage device is configured to store the target exposure setting corresponding to each of the preview frames.

9. The image capturing device as claimed in claim 1, wherein the first preview frame is the preview frame that is currently captured and stored, the second preview frame is the preview frame that is previously captured and stored, and the first and second preview frames are two consecutive preview frames.

10. The image capturing device as claimed in claim 1, further comprising:
a movement sensor configured to detect movement of the image sensor,
wherein the processor is configured to further determine the motion value according to the movement of the image sensor.

11. An image capturing method, comprising:
capturing an image of a target at a predetermined time interval according to a target exposure setting, to provide a series of preview frames at a frame rate;
storing each of the preview frames in a storage device;
obtaining a first preview frame and a second preview frame from the storage device;
determining a motion value of the target according to the first and second preview frames;
updating the target exposure setting according to the motion value of the target; and
capturing the image of the target according to the updated target exposure setting to provide a next preview frame.

12. The image capturing method as claimed in claim 11, further comprising:
in response to a user input, accessing the storage device to obtain the preview frame to be displayed,
wherein the preview frame to be displayed is the preview frame having the image of the target captured when the user input is present.

13. The image capturing method as claimed in claim 11, further comprising:
performing an image processing operation on the preview frame to be displayed, so as to obtain a denoised image; and
displaying the denoised image on a display.

14. The image capturing method as claimed in claim 13, further comprising:
displaying the preview frames at the frame rate on the display.

15. The image capturing method as claimed in claim 11, wherein the frame rate is fixed.

16. The image capturing method as claimed in claim 11, wherein the target exposure setting comprises an exposure value of shutter speed, aperture, and sensitivity.

17. The image capturing method as claimed in claim 11, wherein storing each of the preview frames in the storage device further comprises:
storing the target exposure setting corresponding to each of the preview frames in the storage device.

18. The image capturing method as claimed in claim 11, wherein determining the motion value of the target according to the first and second preview frames further comprises:
detecting movement of a image sensor that captures the image of the target; and
determining the motion value of the target according to the first and second preview frames and the movement of the image sensor.

19. The image capturing method as claimed in claim 11, wherein the first preview frame is the preview frame that is currently captured and stored, the second preview frame is the preview frame that is previously captured and stored, and the first and second preview frames are two consecutive preview frames.
